(19) United States
(12) Patent Application Publication
(10) Pub. No.: US 2009/0197582 A1
(43) Pub. Date: Aug. 6, 2009

(54) PLATFORM FOR MOBILE ADVERTISING AND MICROTARGETING OF PROMOTIONS

(76) Inventors: Robert C. LEWIS, San Diego, CA (US); Giridhar D. MANDYAM, San Diego, CA (US); Anthony M. SHEEHAN, Hove Sussex (GB); Martin C. DICKENS, Warmington (GB)

Correspondence Address: QUALCOMM INCORPORATED, 5775 MOREHOUSE DR., SAN DIEGO, CA, 92121, US

(21) Appl. No.: 12/361,380

(22) Filed: Jan. 28, 2009

Related U.S. Application Data
(60) Provisional application No. 61/025,615, filed on Feb. 1, 2008.

(51) Int. Cl. H04W 4/00

(52) U.S. Cl. 455/414.2

(57) ABSTRACT

An end-to-end mobile advertising system characterizes user behavior (e.g., location, interaction with advertisements on a mobile communication device, etc.) in order to select micro-targeted advertisements. A marketplace platform handles the formatting required for presentation suitable for mobile communication devices in accordance with negotiated tags for a desired audience (“reach”), for a suitable number of presentations (“frequency”) and for an effective duration (“time”) within a particular scheduled window. A condition of schedule for a timed coupon advertisement campaign is supported. Effectiveness is gauged even in the instance of impression advertisements by monitoring user location and/or interaction with the communication device to see a change in behavior (e.g., does not go to a competitor as forecasted, does go to a location of the advertiser, calls the advertiser, clips the advertisement for future reference, etc.). The marketplace platform secures user identification for privacy reasons from advertising entities that provide the advertisements.

### CLAIM OF PRIORITY UNDER 35 U.S.C. §119

The present Application for Patent claims priority to Provisional Application No. 61/025,615 entitled “PLATFORM FOR MOBILE ADVERTISING AND MICROTARGETING OF PROMOTIONS” filed 01 Feb. 2008, and assigned to the assignee hereof and hereby expressly incorporated by reference herein.

### BACKGROUND

Aspects disclosed herein pertain to a communication network that distributes and tracks advertisements presented on a mobile communication device, and in particular, to providing a marketplace platform that serves as a bridge between advertising platforms and a population of mobile communication devices for targeting and tracking particular advertisements suitably formatted and timed for a user of a mobile communication device.

For many years, companies have tried to brand their products, satisfy existing consumers, and reach potential new consumers through traditional means. The evolution has been linear when less creative, and sometimes non-linear, when more creative, as advertising has gone from print forms like newspapers, magazines, brochures, newsletters, press releases and billboards, to event-related activities, like sponsorships, seminars, point-of-sale and promotional programs, to broadcast media, like radio, television, cable and recently satellite cable.

In recent years, there has been a rise of advertising that is more targeted and tailored to individual consumers, with new forms of previously so-called direct advertising. New endeavors have sought to interact directly with consumers through pull campaigns and push campaigns, and make advertising more measurable to bring advertisers specific consumer data mining bearing on consumer buying habits, trending and predicting future habits. Advances in technology outlets combined with marketing ingenuity have expanded the old direct mail marketing campaigns into new branches, including telemarketing, point-of-sale campaigns, computer platforms, and most recently distribution and measurement through telecommunications networks.

With respect to the latter, perhaps the greatest platform for the new world of marketing has been the same as the greatest platform for information exchange in the last decade, namely the Internet. Through such avenues as branded websites, banner ads, pop-up ads, targeted e-mails, portal sponsorships, to name a few examples, advertisers have been able to hone in on target audiences. Through defined metrics and innovative semantics, like served impressions, click-through rate (CTR), cost per action (CPA), cost per click (CPC), cost per sale (CPS), and cost per thousand (CPM), to name a few, advertisers have been able to measure the results of targeted ads and objectively set fees for performance results obtained. Along with these new advances, and because of the increasingly cosmopolitan nature of business, geopolitics, and integrated telecommunications networks, so too has advertising become increasingly global in nature.

Along with advances in personal computing that enabled expansion of Internet advertising (e.g., desktop and notebook computers and broadband Internet access), advances in technology have also resulted in smaller and more powerful personal computing devices. For example, there currently exist a variety of portable personal computing devices, including wireless computing devices, such as portable wireless telephones, personal digital assistants (PDAs) and paging devices that are each small, lightweight, and can be easily carried by users. With advances in computing technology, consumers are increasingly offered many types of electronic devices (“user equipment”) that can be provisioned with an array of software applications. Distinct features such as email, Internet browsing, game playing, address book, calendar, media players, electronic book viewing, voice communication, directory services, etc., increasingly are selectable applications that can be loaded on a multi-function device such as a smart phone, portable game console, or hand-held computer.

Even with these advances, mobile communication devices tend to have communication bandwidth, processing, and user interface constraints over general purpose computing devices. For example, the screen size, amount of available memory and file system space, amount of input and output capabilities and processing capability may each be limited by the small size of the device. Because of such severe resource constraints, it is desirable, for example, to maintain a limited size and quantity of software applications and other information residing on such remote personal computing devices, e.g., client devices. As such, the computing platforms for such devices are often optimized for a particular telephone chipset and user interface hardware.

Limited attempts to extend advertising to mobile communication devices have generally followed the paradigm of Internet browsing. However, wireless application protocol (WAP) browser usage suffers in comparison to broadband Internet usage with full-size monitors/displays. The amount of content that can be retrieved in a timely fashion at a reasonable cost and displayed is constrained. Limited user input devices along with the small display make web pages difficult to navigate. Consequently, the poor user experiences with WAP have limited its acceptance. It thus follows given the differences in how a user chooses to use a mobile communication device that mobile web advertising has been of marginal quantity and value to advertisers. Even with improvements to capabilities of WAP browsing and advertising making them comparable to other computing devices, further improvements for an end-to-end solution are desired. Thereby, increases in inventory of advertising content with consistent campaign booking and standard metrics can be achieved.

### SUMMARY

The following presents a simplified summary in order to provide a basic understanding of some aspects of the disclosed versions. This summary is not an extensive overview and is intended to neither identify key or critical elements nor delineate the scope of such versions. Its purpose is to present some concepts of the described versions in a simplified form as a prelude to the more detailed description that is presented later.

Although their constraints have limited their use as an advertising channel, mobile communication devices have unique characteristics that can be an opportunity for targeted advertising, including impression advertising. The portability and communication uses of the mobile communication device, in particular, present an opportunity to characterize a user and to track success or failure of advertisements targeted for such a user characterization.

In one aspect, a method is provided for distributing advertisement content to a mobile communication device. A user of a mobile communication device is characterized based upon behavior. An advertisement is selected for presentation on the mobile communication device based upon the characterization of the user. A user response proximate in time to presentation of the advertisement to indicate effectiveness is correlated and reported. Thereby, the unique attributes of a mobile communication device are leveraged. A user is better characterized by their behavior than by suspect demographic information. Advertising investments are better targeted. Limited throughput communication channels to mobile devices are better utilized to those who would benefit by micro-targeted advertisements.

In other aspects, a processor, computer product, and apparatus provide means for utilizing the method for distributing advertisement content to a mobile communication device.

In an additional aspect, an apparatus for distributing advertising content to a mobile communication device includes a storage device containing data structure of behavior of a user sensed by a mobile communication device. A marketplace platform develops a characterization of the user based upon the behavior, and interfaces with an advertisement platform to select an advertisement for presentation on the mobile communication device based upon the characterization of the user. An advertisement tracking component correlates and reports a user response proximate in time to presentation of the advertisement to indicate effectiveness.

In yet a further aspect, a method is provided for presenting advertisement content on a mobile communication device. User behavior is sensed on a mobile communication device for characterizing a user. An advertisement is requested for presentation on the mobile communication device selected based upon the characterization of the user. A user response proximate in time to presentation of the advertisement to indicate effectiveness is tracked for correlating and reporting.

In other aspects, a process, computer product, and apparatus provide a means for performing the method of presenting advertisement content on a mobile communication device.

In yet an additional aspect, an apparatus is provided for presenting advertisement content on a mobile communication device, including a sensor of behavior of a user. A transmitting component reports the sensed behavior to a marketplace platform for developing a characterization of the user based upon the behavior. A receiving component receives an advertisement selected by the marketplace platform for presentation on the mobile communication device based upon the characterization of the user. An advertisement tracking component tracks a user response proximate in time to presentation of the advertisement to indicate effectiveness. This user response is then sent by the transmitting component to the marketplace platform.

To the accomplishment of the foregoing and related ends, one or more versions comprise the features hereinafter fully described and particularly pointed out in the claims. The following description and the annexed drawings set forth in detail certain illustrative aspects and are indicative of but a few of the various ways in which the principles of the versions may be employed. Other advantages and novel features will become apparent from the following detailed description when considered in conjunction with the drawings and the disclosed versions are intended to include all such aspects and their equivalents.

### BRIEF DESCRIPTION OF THE DRAWINGS

FIG. 1 is a block diagram of an end-to-end mobile advertising communication system, according to one aspect.

FIG. 2 is a timing diagram of a mobile device, marketplace platform, and advertising platform of the end-to-end mobile advertising communication system, according to another aspect.

FIG. 3 is a schematic diagram of an illustrative end-to-end mobile advertising communication system, according to still another aspect.

FIG. 4 is a diagram of an illustrative graphical user interface for campaign management of the communication system of FIG. 3, according to one aspect.

FIG. 5 is a block diagram of a mobile communication device of FIG. 3, according to still another aspect.

FIG. 6 is a flow diagram of a methodology for mobile communication device advertising performed by the communication system of FIG. 3, according to yet another aspect.

FIG. 7 is a flow diagram of a methodology for end-to-end mobile advertising, in accordance with one aspect.

FIG. 8 is a flow diagram of a methodology for location-informed behavioral profiling of the methodology of FIG. 7, in accordance with another aspect.

FIG. 9 is a flow diagram of a methodology for reach-frequency-time advertising of the methodology of FIG. 7, according to still another aspect.

FIG. 10 is a flow diagram of a methodology for interceptor micro-targeting advertising of the methodology of FIG. 7, according to yet another aspect.

FIG. 11 is a flow diagram of a methodology for timed coupon advertising of the methodology of FIG. 7, according to still another aspect.

FIG. 12 is a flow diagram of a methodology for sequenced advertising of the methodology of FIG. 7, according to one aspect.

FIG. 13 is a block diagram of a network distribution device having modules in computer-readable storage medium executed by at least one processor for distributing advertisement content to a mobile communication device, according to one aspect.

FIG. 14 is a block diagram of a mobile communication device having modules in computer-readable storage medium executed by at least one processor for presenting advertisement, according to one aspect.

### DETAILED DESCRIPTION

An end-to-end mobile advertising system provides a marketplace platform that characterizes user behavior (e.g., location, interaction with advertisements on a mobile communication device, etc.) in order to select micro-targeted advertisements from an advertisement platform. The marketplace platform handles the formatting required for presentation suitable for communication devices. The advertisements are presented in accordance with negotiated tags for a suitable audience (“reach”), for a suitable number of presentations (“frequency”) and for an effective duration (“time”) within a particular scheduled window. A time coupon advertisement campaign is also supported where advertisement include a schedule condition. Effectiveness is gauged even in the instance of impression advertisements by monitoring user location and/or interaction with the communication device to see a change in behavior (e.g., does not go to a competitor as forecasted, does go to a location of the advertiser, calls the advertiser, clips the advertisement for future reference, etc.). Not only does the marketplace platform handle the interfacing for the particular format needs of mobile communication devices, the marketplace platform secures user identification for privacy reasons from advertising entities that provide the advertisements.

Various aspects are now described with reference to the drawings. In the following description, for purposes of explanation, numerous specific details are set forth in order to provide a thorough understanding of one or more aspects. It may be evident, however, that the various aspects may be practiced without these specific details. In other instances, well-known structures and devices are shown in block diagram form in order to concisely describing these versions.

The apparatus and methods are especially well suited for use in wireless environments, but may be suited in any type of network environment, including but not limited to, communication networks, public networks, such as the Internet, private networks, such as virtual private networks (VPN), local area networks, wide area networks, long haul networks, or any other type of data communication network.

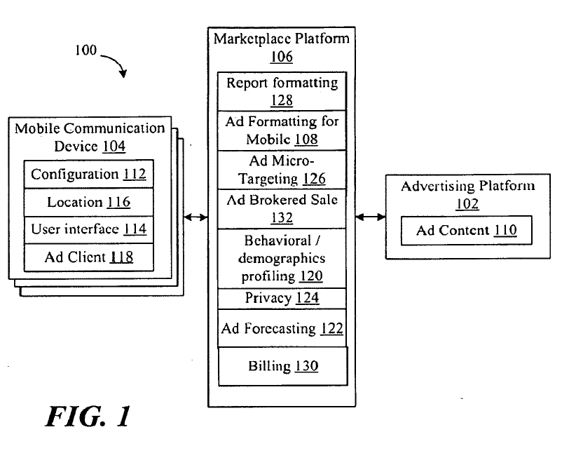

Referring to FIG. 1, according to one aspect, a communication system 100 provides an end-to-end solution for advertisers to extend the reach of their advertising platforms 102 to a population of mobile communication devices 104, even though the mobile communication devices 104 have display, communication bandwidth, and user interaction that differ markedly from other communication channels used by the advertising platforms 102. A marketplace platform 106 provides the interface between the advertising platforms 102 and the mobile communication devices, handling the specific needs of mobile communication devices 104 as well as isolating the user's actual identity from the advertiser. For example, the marketplace platform 106 includes a formatting component 108 that formats advertisements on behalf of the advertising platform 102. Thereby, the different display constraints of various types of mobile communication devices 104 can be accommodated by formatting content provided by an advertising content 110 that is used for other advertising distribution and communication channels (e.g., web portals, etc.). Thus, the advertising platform need not keep up to date with a myriad of presentation constraints for each configuration 112 of mobile communication device 104. The formatting component 108 can enhance the advertisement for suitable interaction options in accordance with a user interface 114 of the particular mobile communication device 104.

The marketplace platform 106 provides additional value to advertisers by determining a “reach” of the population of mobile devices 104. Not only does the marketplace platform 106 know the capabilities for presentation of advertisements, behavior of the user is sensed via the user interface 114 (e.g., call history, interaction with mobile advertisements, etc.) and/or by a location sensing component 116 of the mobile communication device 104. These behavior indications are reported by an advertising client 118, also resident on the mobile communication device 104. Thereby, the marketplace platform 106 can go beyond “suspect” demographic data about the mobile communication devices 104 by storing behavioral and demographics data in a database 120. An advertisement forecasting component 122 analyzes this data in order to characterize the directly sensed or interpreted behavior of a user of the mobile communication device 104.

When the mobile communication device 104 needs additional advertisements, the advertising client 118 makes a request, which is forwarded by the marketplace platform 106. While achieving the latter, individual identifications are filtered out with a privacy component 124, such that the advertising platform 102 knows only a characterization of the mobile communication device 104. Alternatively, the marketplace platform 106 has access to a range of advertisements in the advertisement content 110 of the advertising platform 102 and utilizes an advertisement micro-targeting component 126 to select appropriate advertisements for the requesting mobile communication device 104 in accordance with a characterization maintained by the advertising forecasting component 122. The mobile communication device 104 presents the advertisement on the user interface 114 and reports the usage via the advertising client 118 to the marketplace platform 106. The data can be processed by a report formatting component 128 in accordance with a data format compatible with the advertising platform 102 so that advertisers can assess the effectiveness of an advertisement campaign. Data can also be used to provide heuristics, trends, or categorizations about/of the user for future advert selection. The advertisement tracking data can also be processed by a billing component 130, especially in instances where the amount of payment owed to the marketplace platform 106 is related to the advertisement tracking data. In instances where users have interacted in a way with the user interface 114 indicating a desire to purchase goods or services associated with a presented advertisement, the marketplace platform 106 can provide an advertisement brokered sale component 132, leveraging current billing avenues, authentication methods, and privacy filters in order to facilitate a transaction between the advertising platform 102 and a user of the mobile communication device 104.

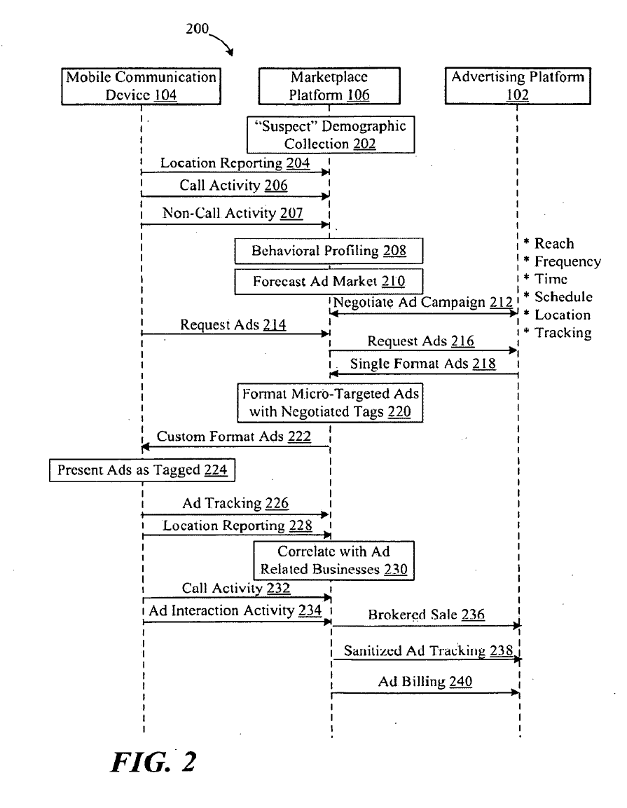

In FIG. 2, in accordance with one aspect, a methodology 200 for end-to-end mobile advertising is depicted by interactions between the mobile communication device 104, the marketplace platform 106, and the advertising platform 102. The marketplace platform 106 begins by processing a collection of demographic data in block 202. Such data has value, but is denoted as “suspect” in that users do not always provide accurate or complete self-assessments for a number of reasons. This demographic data is augmented at 204 by location reporting provided by the mobile communication device 104 to the marketplace platform 106. This location data can be approximate, given a current cell or wireless node from which the communication originates. This location data can be accurately determined from a Global Positioning System (GPS) engine incorporated into the mobile communication device 104, sufficiently accurate to identify the location of the user to specific physical addresses. In addition, user behavior is provided by call activity, depicted as reports at 206. Alternatively or in addition, user behavior is provided by non-call activity (e.g., WAP browser interaction, etc.), depicted at 207. This collected user behavior data is analyzed for behavioral profiling at block 208. As used herein, a behavioral profile encompasses the demographic variables, behavior variables, and other information that goes toward IAO variables (i.e., interests, attitudes, and opinions), although it should be appreciated that some applications consistent with aspects herein are confined to a subset of such variables. The behavioral profiling can incorporate an initial or periodic “fuzziness” factor. Initial matching for a user is initially loose due to limited data, which tightens as additional information is learned about the user. However, reintroduction of “fuzziness” can provide a benefit of eliciting additional feedback at a user without focusing in on what may be a limited set of interests or interests that change with time. Some randomness or increased fuzziness can thus be injected to disturb the close loop system.

In block 210, the marketplace platform 106 performs a forecast of the advertising market of the mobile communication devices 104. For example, current advertising usage and the usage of the mobile communication devices 104 overall can be combined with propensity of certain users of mobile communication devices 104 to benefit from a particular advertiser based on the behavioral profiling. This ad forecast can serve as a basis for negotiating an advertisement campaign with the advertising platform 102, as depicted at 212. The campaign can be defined in terms of reach (e.g., a subset of users of mobile communication devices 104 with a high correlation for the goods or services based on behavioral profile), frequency of advertisement presentations to each user, the cumulative viewing time of an advertisement for each selected user, and/or a location limitation for users proximate to a competitor or the advertiser's business locations. The campaign can be defined in terms of sequence, in which a story can be told by conditioning display of one advertisement upon the user being shown a preceding entry. An advertisement campaign can be constrained to a particular calendar schedule with limitations on a begin time and/or an end time. The schedule constraint can also comprise a time of day schedule limitation for campaigns that focus on users who are active at a particular time, such as those who would be influenced to visit a restaurant close to dinner time or to attend a concert. The marketplace platform 106 can also provide tracking of advertisement usage that can serve as a valuable feedback tool for the advertisers to determine effectiveness. The tracking can also serve as a basis for valuing the end-to-end mobile advertising services of the marketplace platform 106.

With the advertising campaign set up, when a mobile communication device 104 signals the marketplace platform 106 at 214 that additional advertisements are needed, the marketplace platform 106 requests single-format advertisements from the advertisement platform at 216. The advertising platform 102 provides the single format advertisements at 218.

At block 220, the marketplace platform 106 formats one or more advertisements into a format suitable for the requesting mobile communication device 104. The marketplace platform 106 micro-targets the advertisements to those mobile communication devices 104 that are deemed to have an appropriate behavioral profile. Part of the formatting includes tagging conditions in accordance with the negotiated terms for the advertising campaign. Examples of these tags are frequency of presentation, duration of presentation, sequence, schedule window, location constraints, etc. The custom formatted advertisements are sent from the marketplace platform 106 to the mobile communication device 104 at 222. An advertisement format can choose to use multiple single formats (e.g. a hotspot that blooms on receiving focus, moving from one advert size to another).

At 224, the mobile communication device 104 presents the advertisements in accordance with the tagged conditions. The tracking of advertisement usage by the mobile communication device 104 is reported intermittently to the marketplace platform 106 as depicted at 226. In addition, some aspects include location reporting as depicted at 228. With this advertisement and location tracking, the marketplace platform 106 correlates the advertisement presentation with the location of the user against a database of monitored locations (e.g., competitors, advertiser's business locations, etc.) in order to infer success or failure of impression advertisements. The mobile communication device 104 in some aspects reports call activity as depicted at 232, such as dialed directly by the user or automatically dialed by using a “click to dial” feature of the mobile communication device 104. In some aspects, at 234 the mobile communication device 104 can report advertisement interaction activity (e.g., “click to clip” to save the advertisement for future review by the user, “click to glance” to launch a window to view the advertisement or a more detailed version of the advertisement, “click to locate” to guide the user to the location of the advertiser, etc.).

It should be appreciated with the benefit of the present disclosure that certain mandated or user selectable location privacy settings can be imposed. For example, location tracking could be confined within the UE or otherwise protected within the network. Behavior characterizations for example could be implemented wherein the UE requests and caches points of interest within the locale associated in requesting refreshing of cached advertisements.

It should be appreciated with the benefit of the present disclosure that certain user actions such as clipping an advertisement warrant particular attention in selection of future advertisements to remind the user of this deferred action. Alternatively or in addition, the UI can prompt the user at an appropriate time whether or not the clipped advertisement should be redisplayed. Alternatively or in addition, reporting to the marketplace platform can specify this type of action.

The tagged conditions can facilitate the user behavior by providing information or active content that direct the user toward the behavior that is to be tracked. In some instances, an advertiser may specify that only certain kinds of user behavior are to be tracked, or certain behaviors are weighted more heavily as indicating an effective advertisement. For example, a click to locate action can be a stronger indication than a click to save, which in turn can be a stronger indication than a location proximity that is not necessarily proof of visiting the advertising business.

At 236, based on the reported usage data, the marketplace platform 106 can have an opportunity to perform a brokered sale with the advertising platform 102 based on certain kinds of user interactions with the advertisement. At 238, based on the reported usage data, the marketplace platform 106 can report depersonalized advertisement tracking data to the advertising platform 102. This depersonalization can apply to both anonymized individual subscriber data and aggregate multiple subscriber data. In both cases, such depersonalization removes knowledge of a specific user's characteristics. This depersonalizing can summarize the data into a format conforming to the data of interest to the advertiser. The depersonalizing can replace individual identification with a categorization of the consumers of the advertisement in order to preserve user privacy. At 240, the marketplace platform 106 can report advertisement billing, such as basing the amount due as corresponding to the usage tracking.

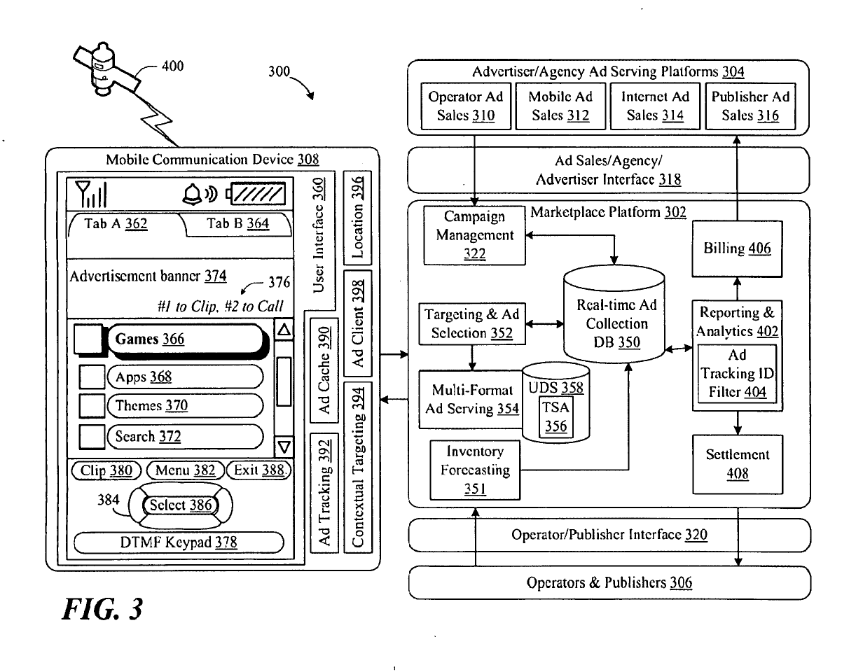

In FIG. 3, according to one aspect, an exemplary communication system 300 benefits from a marketplace platform 302 that interfaces between advertiser/agency advertisement serving platforms 304, operators and publishers 306, and a population of mobile communication devices 308. The advertising serving platforms 304 can comprise operator advertising sales 310, mobile advertising sales 312, Internet advertising sales 314, and/or publisher advertising sales 316, etc., whose particular communication protocols are accommodated by an advertisement sales/agency/advertiser interface 318 to communicate with the marketplace platform 302. In some aspects, operators (e.g., wireless/cellular carrier) 306 can perform functions such as billing and assisting in estimating an available population of mobile communication devices 308 by communicating with the marketplace platform 302 via an operator/publisher interface 320. The mobile advertising platform 302 includes a campaign management component 322 that allows an administrator to select appropriate formatting and condition tagging.

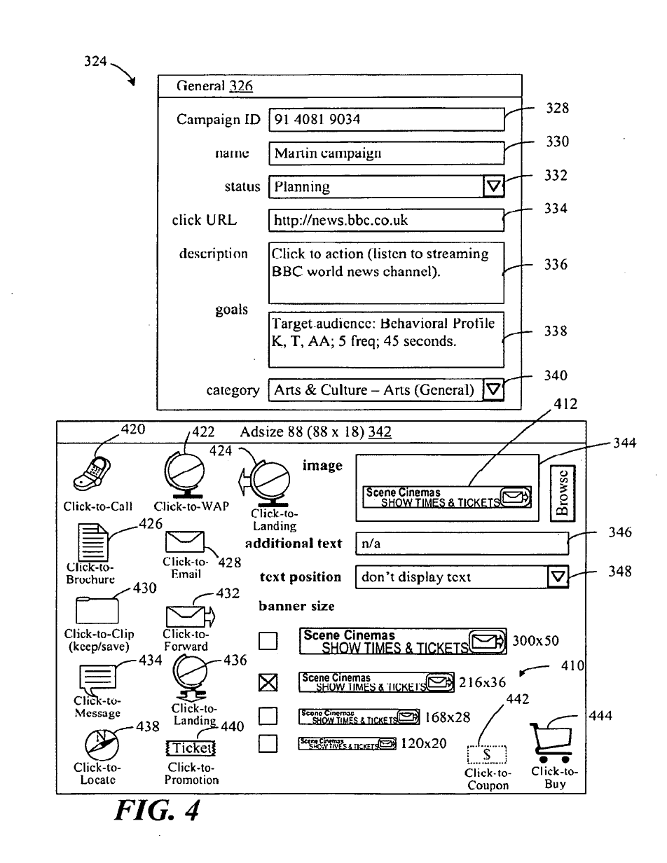

In FIG. 4, according to one aspect, an illustrative graphical user interface 324 includes a general window 326 that enables a user to enter a campaign identification entry field 328 (e.g., 91 4081 9034), a campaign name entry field 330 (e.g., Martin campaign), a campaign status pull-down menu 332 (e.g., planning), a click-to-action link 334 (i.e., uniform resource locator (URL), e.g., http://news.bbc.co.uk), a campaign description entry field 336 (e.g., click to action—listen to streaming BBC world news channel), campaign goals entry field 338 (e.g., target audience, behavioral profile categories K, T, AA, frequency 5, time duration 45 seconds), and a category pull-down menu 340 (e.g., Arts & Culture—Arts (General)). It should be appreciated with the benefit of the present disclosure that time can be shown should have minimum and an optimum (i.e., minimum stops the page from exiting until period is up; optimum allows the ad to disappear once the period is up).

In an exemplary version, both the mobile communication devices 308 are BREW-enabled. The Binary Runtime Environment for Wireless® (BREW®) software, developed by QUALCOMM Incorporated of San Diego, Calif., exists over the operating system of a computing device, such as a wireless cellular phone. BREW® can provide a set of interfaces to particular hardware features found on computing devices. As such, the click-to-action link 334 can include a BREW “click URL” or other instructions as to how the user can interact with the advertisement (e.g., click to clip, click to call, click to glance, etc.). In order to enhance user experience, a “click to stop” can be provided to allow for the user to block future occurrences of this advertisement or those like it.

The graphical user interface 324 also provides a specific configuration for a subset of the mobile configuration devices 308 operating with a specific chipset, hardware, and/or software configuration. In an illustrative window 342, the user has selected a mobile advertisement size of 88, which is defined as 88 pixels wide by 18 pixels high. An image selection field 344 allows the campaign administrator to select an image, such as an image provided by the advertiser that has been manually resized or automatically cropped and reduced and/or changed in color palette by the widow 342. Additional text entry field 346 may be used, such as for instructions for displaying how to interact with this advertisement that is specific to this configuration of mobile communication device 308. A text position pull-down menu 348 can position this additional text, or omit it altogether as in given in the example.

Returning to FIG. 3, the customized settings for advertisements from the campaign management component 322 are stored in a real-time ad collection database 350. Data provided by operators/publishers 306 can be processed by an inventory forecasting component 351 with forecast data stored in ad collection database 350. A targeting and advertisement selection component 352 matches advertisement requests from the mobile communication devices 308 with the customized advertisements in the ad collection database 350.

A mobile user interface 360 in the illustrative version includes a tab A 362 and a tab B 364 (e.g., “mystuff”, which can include clipped advertisements subfolder). The depicted tab A 362 is selected, showing options, such as selected Games shopping option 366, an applications (“apps”) shopping option 368, a themes shopping option 370, and a shopping search option 372. An advertisement banner advertisement 374 is displayed with additional text 376 (e.g., “#1 to Clip, #2 to Call) explaining how a user can interact with the advertisement 374, such as using a dial tone multi-frequency (DTMF) keypad 378, a dedicated advertisement interaction button (e.g., Clip) 380, and a menu button 382 to reach additional advertisement options perhaps used in conjunction with a steering buttons 384 and a select button 386. An exit button 388 allows backing out of a menu sequence.

The mobile communication device 308 provides functions that operate to support and monitor the user interaction with advertisements 374, such as an advertisement cache 390, an advertisement tracking component 392, a contextual targeting component 394, a location monitoring and reporting component 396, and an advertising client 398, which in the illustrative version is a BREW extension. The location monitoring and reporting component 396 can derive location from a Global Positioning System (GPS) 400. Alternatively, radio frequency identification systems, wireless access points, cellular direction finding, etc., can provide approximate location information about a mobile communication device that is temporarily screened from GPS reception or lacks an inherent location sensing capability.

The mobile advertising platform 302 stores the data received from the mobile communication devices 308 in the real-time ad collection database 350. A reporting and analytics component 402 summarizes, filters, and formats the data received from the ad collection database 350, advantageously filtered of individual identification information by an advertisement tracking identifier filter 404. The prepared data is used by a billing component 406 that sends bills to advertising serving platforms 304 and/or by a settlement component 408 that interacts with operators and publishers 306.

Returning to FIG. 4, the window 342 can facilitate advertisement action and icon selection that is appropriate for the capabilities of the type of mobile communication device 308, appropriate for the communication avenues allowed by the advertiser (e.g., text messaging, emailing, webpage, telephone call, etc.), and/or optimum for revenue generating potential for the marketplace advertisement platform 302. A plurality of banner size selection radio buttons and depictions 410 can change the rendering of a selected banner 412 in the image selection field 344 to make it appropriate for a particular type of mobile communication device 308.

A range of actions, represented by their assigned icon, can be selected for incorporation, such as by drag and drop or by selecting. In some applications, those action icons are disabled (e.g., grayed out) if not appropriate for the particular advertisement, such as not having corresponding action information defined in general window 326, or if not available on the type of mobile communication device 308. Although not depicted, the selection can allow multiple actions to be added to the advertisement if supported by the mobile communication device 308. Alternatively or in addition, a hierarchy of preferred action choices when multiple choices are available can be specified with the first choice displayed. The action icon actually displayed on a particular mobile communication device 308 could be dynamically changed to accommodate a limitation on the user's contractual relationship or the local access network. For example, the user may not have paid for short message service or the service may not be available at a certain locale.

Examples of action icons that are suggestive of function as well as giving a wide range of interaction possibilities for advertisements include, but are not limited to, the following: (1) A click-to-call icon 420 dials the number as specified by the advertiser to encourage calling; (2) A click-to-WAP (wireless application protocol) icon 422 launches a browser allowing the user to manually type in a link provided on the advertising banner 412; (3) A click-to-landing icon 424 allows the browser to return to a prior page or a home page, which can be desired due to the slow page loading for mobile communication device 308 using a limited throughput wireless channel; (4) Click-to-brochure icon 426 renders a document depiction for additional information about the advertisement; (5) A click-to-email icon 428 sends an automated email response to the advertiser; (6) Click-to-clip (keep/save) icon 430 saves the advertisement for later accessing; (7) A click-to-forward icon 432 launches a utility to forward the advertisement to an addressee manually entered or one in their address book; (8) A click-to-message icon 434 accesses a short message utility pre-addressed to the advertiser; (9) A click-to-content icon 436 navigates to a web link provided by the advertiser; (10) A click-to-locate icon 438 pops up a map to the advertiser, perhaps the closest location with reference to location information from the mobile communication device 308; (11) A click-to-promotion icon 440 can activate information about how to enter a sweepstakes, contest, promotion etc.; (12) A click-to-coupon icon 442 can access a barcode, alphanumeric password, etc. for entering into a full browser, a mail-in redemption, or to show to a retailer on the mobile communication device 308 in order to access a discount deal; and (13) A click-to-buy icon 444 initiates a purchase transaction. In some applications, the service provider for the mobile communication device 308 can enhance the transaction by providing the shipping and/or billing information for the user associated with the device 308, including adding the purchase to the service billing.

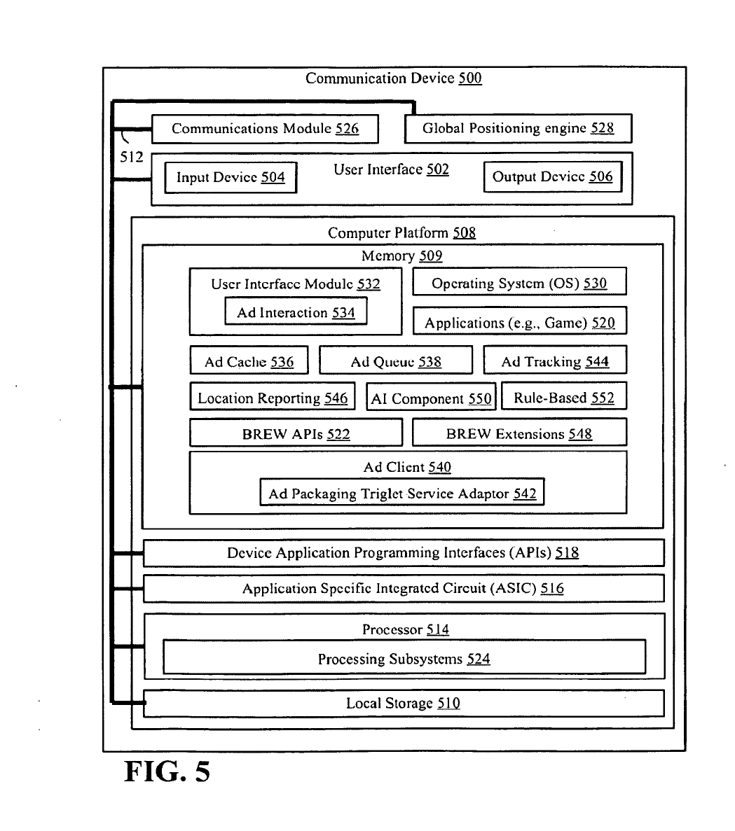

In FIG. 5, an exemplary version of a communication system 500 is depicted according to some aspects as any type of computerized device, according to one aspect. For example, the communication device 500 may comprise a mobile wireless and/or cellular telephone. Alternatively, the communication device 500 may comprise a fixed communication device, such as a Proxy Call/Session Control Function (P-CSCF) server, a network device, a server, a computer workstation, etc. It should be understood that communication device 500 is not limited to such a described or illustrated devices, but may further include a Personal Digital Assistant (PDA), a two-way text pager, a portable computer having a wired or wireless communication portal, and any type of computer platform having a wired and/or wireless communications portal. Further, the communication device 500 can be a remote-slave or other similar device, such as remote sensors, remote servers, diagnostic tools, data relays, and the like, which does not have an end-user thereof, but which simply communicates data across a wireless or wired network. In alternate aspects, the communication device 500 may be a wired communication device, such as a landline telephone, personal computer, set-top box or the like. Additionally, it should be noted that any combination of any number of communication devices 500 of a single type or a plurality of the afore-mentioned types may be utilized in a cellular communication system (not shown). Therefore, the present apparatus and methods can accordingly be performed on any form of wired or wireless device or computer module, including a wired or wireless communication portal, including without limitation, wireless modems, Personal Computer Memory Card International Association (PCMCIA) cards, access terminals, personal computers, telephones, or any combination or sub-combination thereof.

Additionally, the communication device 500 may include a user interface 502 for purposes such as viewing and interacting with advertisements. This user interface 502 includes an input device 504 operable to generate or receive a user input into the communication device 500, and an output device 506 operable to generate and/or present information for consumption by the user of the communication device 500. For example, input device 502 may include at least one device such as a keypad and/or keyboard, a mouse, a touch-screen display, a microphone in association with a voice recognition module, etc. Further, for example, output device 506 may include a display, an audio speaker, a haptic feedback mechanism, etc. Output device 506 may generate a graphical user interface, a sound, a feeling such as a vibration or a Braille text producing surface, etc.

Further, communication device 500 may include a computer platform 508 operable to execute applications to provide functionality to the device 500, and which may further interact with input device 504 and output device 506. Computer platform 508 may include a memory, which may comprise volatile and nonvolatile memory portions, such as read-only and/or random-access memory (RAM and ROM), erasable programmable read-only memory (EPROM), electrically erasable programmable read-only memory (EEPROM), flash memory, and/or any memory common to computer platforms. Further, memory may include active memory and storage memory, including an electronic file system and any secondary and/or tertiary storage device, such as magnetic media, optical media, tape, soft and/or hard disk, and removable memory components. In the illustrative version, memory is depicted as RAM memory 509 and a nonvolatile local storage component 510, both connected to a data bus 512 of the computer platform 508.

Further, computer platform 508 may also include a processor 514, which may be an application-specific integrated circuit (ASIC), or other chipset, processor, logic circuit, or other data processing device. In some aspects, such as when communication device 500 comprises a cellular telephone, processor or other logic such as an application specific integration circuit (ASIC) 516 may execute an application programming interface (API) 518 that interfaces with any resident software components, depicted as applications (e.g., games) 520 that may be active in memory 509 for other functions (e.g., communication call control, alarm clock, text messaging, etc.). It should be appreciated with the benefit of the present disclosure that applications consistent with aspects of the present disclosure may omit other applications and/or omit the ability to receive streaming content such as voice call, data call, and media-related applications in memory 509. Device APIs 518 may run on top of a runtime environment executing on the respective communication device. One such API 518 is Binary Runtime Environment for Wireless® (BREW®) API 522, developed by QUALCOMM Incorporated of San Diego, Calif.

Additionally, processor 514 may include various processing subsystems 524 embodied in hardware, firmware, software, and combinations thereof, that enable the functionality of communication device 500 and the operability of the communication device 500 on communications system 300 (FIG. 3). For example, processing subsystems 524 allow for initiating and maintaining communications, and exchanging data, with other networked devices as well as within and/or among components of communication device 500. In one aspect, such as in a cellular telephone, processor 514 may include one or a combination of processing subsystems 524, such as: sound, non-volatile memory, file system, transmit, receive, searcher, layer 1, layer 2, layer 3, main control, remote procedure, handset, power management, diagnostic, digital signal processor, vocoder, messaging, call manager, Bluetooth® system, Bluetooth® LPOS, position determination, position engine, user interface, sleep, data services, security, authentication, USIM/SIM (universal subscriber identity module/subscriber identity module), voice services, graphics, USB (universal serial bus), multimedia such as MPEG (Moving Picture Experts Group) protocol multimedia, GPRS (General Packet Radio Service), short message service (SMS), short voice service (SVS™), web browser, etc. For the disclosed aspects, processing subsystems 524 of processor 514 may include any subsystem components that interact with applications executing on computer platform 508.

Computer platform 508 may further include a communications module 526 that enables communications among the various components of communication device 500, as well as being operable to provide communications related to receiving and tracking advertisements presented on and/or interacted with the user interface 502. Communications module 526 may be embodied in hardware, firmware, software, and/or combinations thereof, and may further include all protocols for use in intra-device and inter-device communications. A GPS engine 528 or other location sensing components provide location information of the communication device 500.

Certain of these capabilities of the communication device 500 can be facilitated by code loaded from local storage 510, retained in memory 509, and executed by the processor 514, such as an operating system (OS) 530. A user interface (UI) module 532 facilitates interactive control with the user interface 502. The UI module 532 includes an advertising interaction component 534 that provides tailored interaction options for particular advertisements that are drawn from an advertisement cache 536 in an order specified by an advertisement queue 538 ordered by an advertising client 540, in particular an advertising packaging Triglet service adaptor 542. The usage of advertisements is captured by an advertising tracking component 544. A location reporting component 546 can include logic that selectively reports device location.

In one aspect, the BREW APIs 522 provide the ability for applications to call Device APIs 518 and other functions without having to be written specifically for the type of communication device 500. Thus, an application 520 or components for end-to-end mobile advertising on the communication device 500 may operate identically, or with slight modifications, on a number of different types of hardware configurations within the operating environment provided by BREW API 522, which abstracts certain hardware aspects. A BREW extension 548 adds additional capability to the programming platform of the BREW API 522, such as offering MP3 players, Java Virtual Machines, etc. As an example, the UI module 532 can be a BREW extension 548.

In order to distribute computational overhead and/or to reduce transmission overhead on the communication system 300 (FIG. 3), an artificial intelligence (AI) component 550 and/or a rule-based logic component 552 can infer user behavior for reporting, make decisions as to when a reportable advertising-related event has occurred, and/or extrapolate location based on intermittent location sensing, etc.

The rules-based logic component 552 can be employed to automate certain functions described or suggested herein. In accordance with this alternate aspect, an implementation scheme (e.g., rule) can be applied to define types of attributes that should be acted upon or ignored, correlate language elements to attributes, create rules that are aware of location sensing status, sensing a delay in last user interaction to determine if advertisement viewing is occurring, etc. By way of example, it will be appreciated that the rule-based implementation can automatically define criteria for types of user interactions that can be partially intruded upon by an advertisement. For example, during loading of a game, an advertisement can be allowed to be displayed full screen. When a half-screen application is running, example a text messaging application, then an advertisement banner can be displayed, which a user can selectively enable in order to receive subsidized service rates, for example. The rule-based logic component 552 could request impression advertising over click to action advertising in response to an inference made that the user does not directly interact with advertisement. In response thereto, the rule-based implementation can change the amount of notifications given, the level of detail provided, and/or prevent edits altogether that would result in a reset.

The AI component 550 can facilitate automating performance of one or more features described herein such as predicting user behavior, extrapolating intermittent location data, adjusting advertisement interaction options based on machine learning. Thus, employing various AI-based schemes can assist in carrying out various aspects thereof. For instance, the AI component 550 could be trained in a learning mode wherein the user's location is analyzed against a database of locations in order to create the behavioral profile. Then, certain patterns of user behavior can be classified.

A classifier is a function that maps an input attribute vector, x=(x1, x2, x3, x4, xn), to a class label class(x). A classifier can also output a confidence that the input belongs to a class, that is, f(x)=confidence(class(x)). Such classification can employ a probabilistic and/or statistical-based analysis (e.g., factoring into the analysis utilities and costs) to predict or infer an action that a user desires to be automatically performed.

A support vector machine (SVM) is an example of a classifier that can be employed. The SVM operates by finding a hypersurface in the space of possible inputs that splits in an optimal way the triggering input events from the non-triggering events. Other classification approaches, including Naïve Bayes, Bayesian networks, decision trees, neural networks, fuzzy logic models, maximum entropy models, etc., can be employed. Classification as used herein also is inclusive of statistical regression that is utilized to develop models of priority.

As will be readily appreciated from the subject specification, the subject disclosure can employ classifiers that are pre-trained (e.g., via a generic training data from multiple users) as well as methods of reinforcement learning (e.g., via observing user behavior, observing trends, receiving extrinsic information). Thus, the subject disclosure can be used to automatically learn and perform a number of functions, including but not limited to determining, according to a predetermined criteria, what constitutes a reset condition of concern, when/if to communicate impending controller reset, when/if to prevent a controller reset, preferences for types of data to exchange, etc.

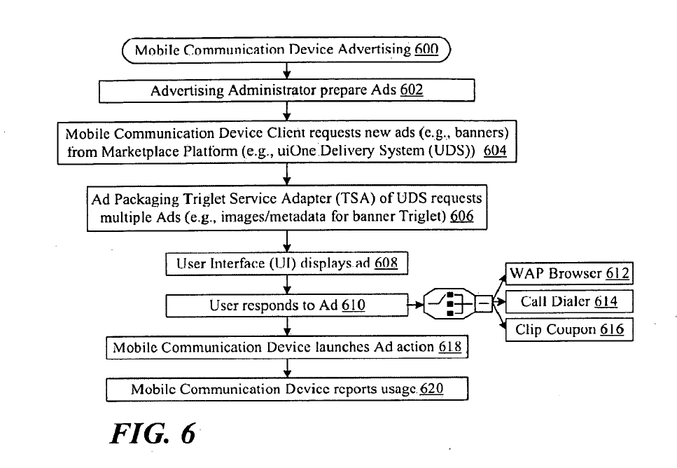

In FIG. 6, a methodology 600 for mobile communication device advertising largely performed by the communication system of FIG. 3 begins in block 602 with an advertising administrator preparing an advertisement for deployment on mobile communication devices, according to one aspect. A mobile communication device client requests new advertisements, such as banner advertisements, from the marketplace platform in block 604. In block 606, the advertising packaging Triglet Service Adapter (TSA) of UDS requests multiple advertisements (e.g., images, metadata, etc.). In block 608, with the advertisements now received by the mobile communication device, the user interface displays a banner advertisement. In block 610, the advertisement provides one or more methods for a user to interact or respond to the advertisement. For instance, a wireless application protocol (WAP) browser can be activated by a “click to glance” operation in block 612. As another example, a “click to call” can be automatically invoked or a manually dialed called correlated to a telephone number displayed on the advertisement, depicted at 614 as “call dialer.” As yet another example, the user interface can provide a coupon clipping function, depicted at block 616. In response to this interaction, the mobile communication device launches the advertisement action as requested in block 618. This interaction is then tracked for reporting advertisement usage in block 620.

It should be appreciated that certain illustrative tools are presented to facilitate a mobile advertising campaign; however, it is contemplated that the tools enhance the ability for an advertising to set up a campaign that suits their needs, not to have the designer/administrator drive the campaign.

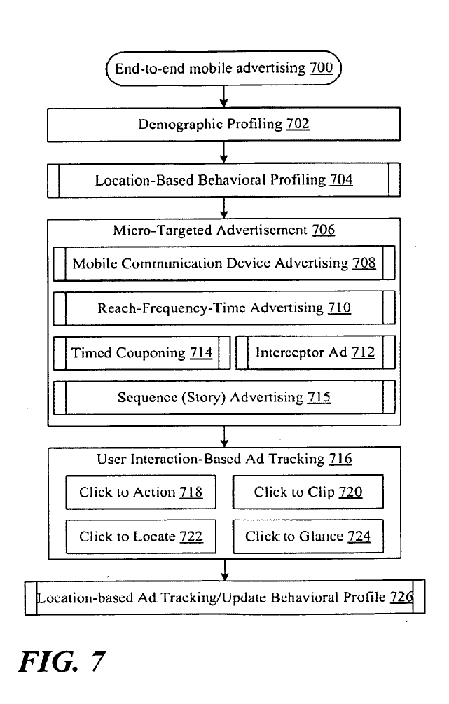

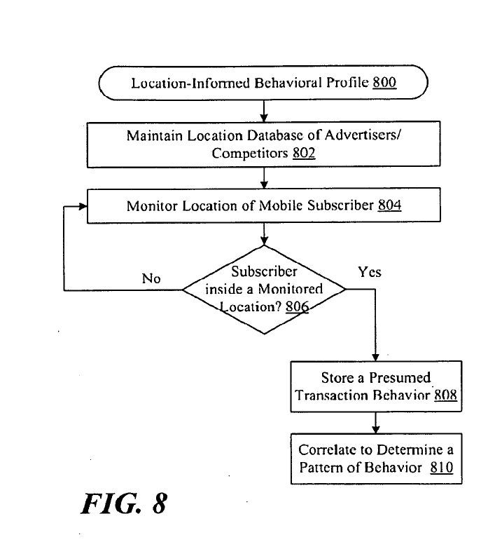

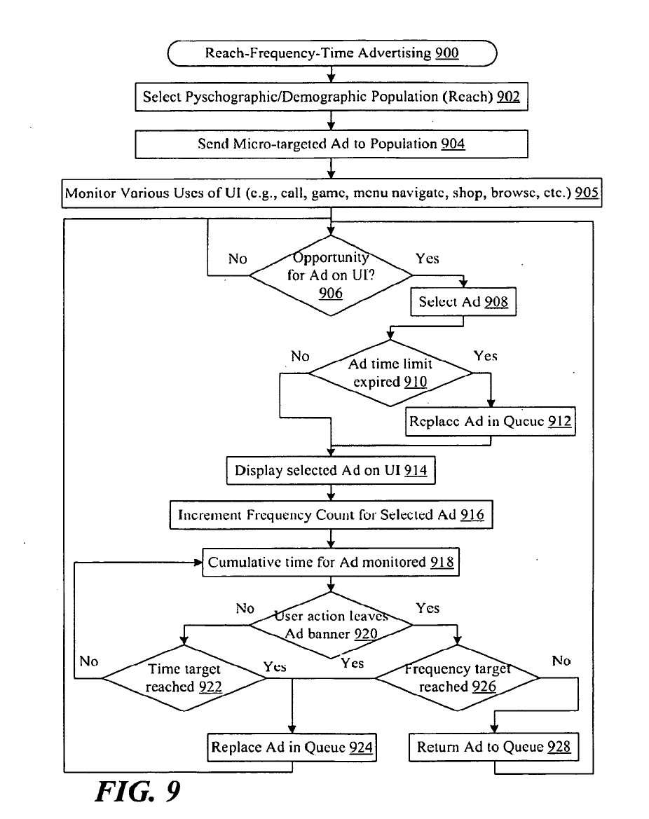

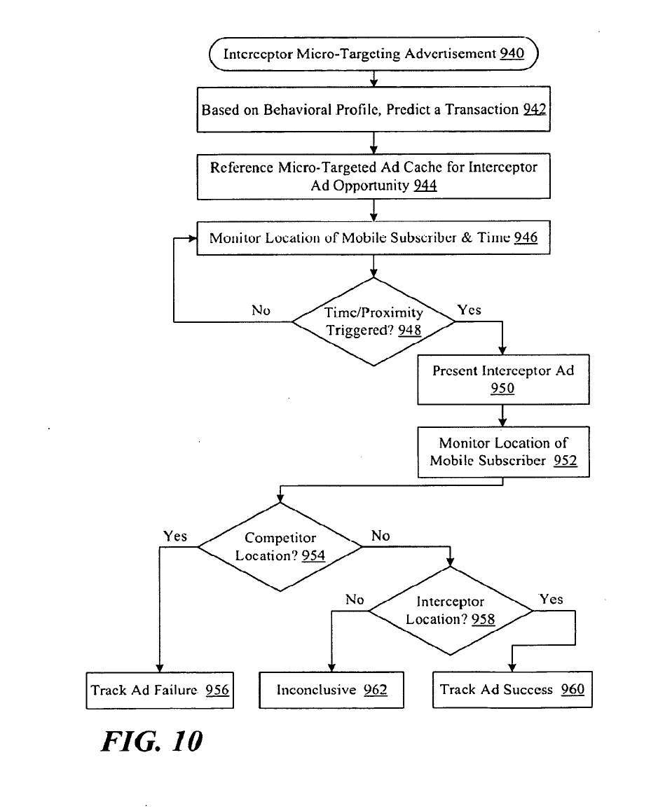

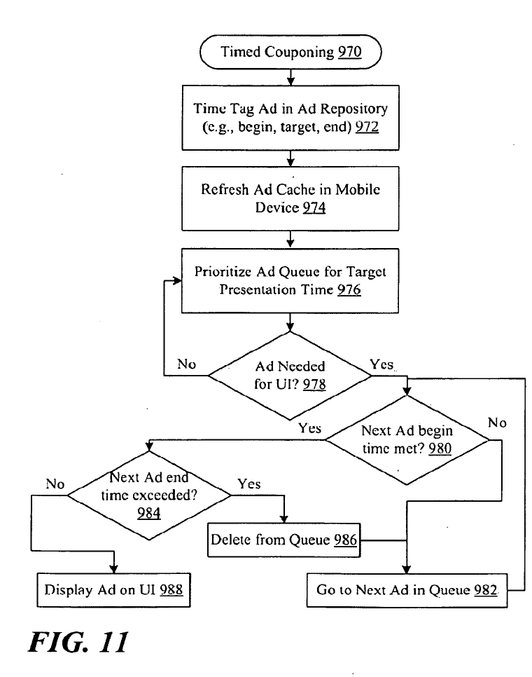

In FIG. 7, a methodology 700 for end-to-end mobile advertising can include features enabled by location sensing of the mobile communication devices, according to one aspect. In block 702, demographic profiling is collected and maintained, although the weight given to such inputs can be limited. In block 704, location-based behavioral profiling is performed, based upon location reports from mobile communication devices that can infer behavioral preferences of a user of the device. This process is discussed below with regard to FIG. 8. In block 706, micro-targeted advertisement process is performed, as discussed above for FIG. 6, in support of location-disabled mobile communication devices. Another aspect is in block 710 discussed below with regard to FIG. 9, provides for reach-frequency-time advertising. An additional aspect is in block 712 leverages the location and condition tagging capabilities to perform an interceptor advertisement campaign, discussed below with regard to FIG. 10. Yet a further aspect in block 714 leverages the condition tagging capabilities in order to provide timed couponing advertisements, discussed below with regard to FIG. 11. Yet in another aspect in block 715 leverages sequence condition tagging capabilities in order to provide sequenced (story) advertising campaigns.

In block 716, advertising tracking can comprise in whole or in part tracking of user interaction with the advertisement. In one aspect, user interaction can comprise a click to action (block 718), which can cause a click to navigate to a web page of the advertiser. Click to action can also invoke a request to receive a call from the advertiser or to caller the advertiser. Click to action can also invoke SMS or other communication channels. In another aspect, user interaction can be click to clip (block 720) that allows a user to clip advertisements for later viewing. For example, clipping an advertisement in the middle of gameplay avoids disrupting the user experience. Promotional content can be saved for repeated viewing, such as viral videos that provide entertainment or informational value to the user while serving as impression or brand advertising for the advertiser. As a further aspect, the user interaction can be click to locate in block 722. For example, activating the advertisement can launch navigation information to the location of the advertiser. Click to locate can comprise being sensed as entering the location of the advertiser, which is deemed as a successful impression advertisement. Click to locate can comprise a user taking his advertisement display to the advertiser as an electronic discount coupon, which can be manually or automatically correlated with the advertisement for tracking of success. In yet another aspect, the user interaction can comprise click to glance (block 724), wherein an application is launched in another window of the user interface of the mobile communication device.

In FIG. 8, a methodology 800 for performing location-informed behavioral can comprise maintaining a location database of advertisers and competitors in block 802, according to one aspect. Such location correlation can include prospective advertisers that can be approached about end-to-end mobile advertising. In block 804, locations of mobile subscribers are monitored. When a subscriber is determined to be in a monitored location in block 806, then a presumed transaction behavior is stored in block 808. A pattern can be correlated from one or more such presumed transaction behavior instances in order to enhance a behavioral profile of the user in block 810.

In FIG. 9, a methodology 900 for reach-frequency-time advertising begins in block 902 with forecasting a behavioral/demographic population of mobile communication devices that can benefit from a particular advertisement for goods or services, according to one aspect. A micro-targeted advertisement is sent to this forecasted population in block 904. In block 905, the various uses of the user interface (UI) are monitored, such as use of the calling screen, a text messaging screen, a webpage browsing screen, a game screen, personal organizer screen (e.g., calculator, calendar, contact list, notepad, etc.) depending on the available screen size, etc., advertising space can be available, either during use or when loading and/or exiting a screen. At the device, an opportunity is recognized for presenting an advertisement on the user interface (UI) in block 906. For example, the device UI is activated as a user selects menu options, etc., such that the UI is active and viewing of the advertisement can be presumed.

In block 908, an advertisement is selected from those advertisements cached on the device. If the next advertisement queued for presentation is determined to have expired in block 910, then the next advertisement in the queue is selected in block 912. In block 914, with an unexpired advertisement accessed, the advertisement is presented (e.g., displayed) on the UI. The usage tracking for this advertisement is updated with an incremented frequency count in block 916 and cumulated duration of displayed is monitored in block 918. If a user has not caused an action that would leave the advertisement banner in block 920, then a further determination is made in block 922 as to whether a time target has been reached, either for this particular frequency count or a total duration of display on this mobile communication device. If not, processing returns to block 918. If the time limit is reached in block 922, the advertisement is replaced in the queue in 924 with the next advertisement and processing returns to block 906. If in block 920 the user has taken an action that warrants leaving the advertisement banner, then a further determination is made in block 926 as to whether a frequency count target has been reached. If not, the advertisement is returned or maintained in the queue to be repeated after a suitable interval in block 928 and processing returns to block 906. If the frequency count target has been reach in block 926, then the advertisement is replaced in the queue in block 924 and processing returns to block 906.

The frequency and duration can be prescribed to be associated with a certain use of the wireless device. An advertiser may want a game advertisement to only run on users who use their wireless device for gaming. As another example, use as a telephone can omit advertisements as the user is paying a carrier for this service. By contrast, a discounted or demonstration version of a game can be accepted along with advertisements that warrant the subsidized cost. However, in the illustrative aspect all uses of the user interface (UI) conducive to advertising can be used as opportunities to display advertisements. The calculation of frequency and duration counts each presentation. Thus, cross content advertising includes when an advertising campaign multiple types of wireless device uses. As an illustrative example, consider a wireless device user Joey, who is a 14-year-old male skateboard fan, as determined by his behavioral and demographic profiles. A sports shoe advertiser directs that subscribers should view a shoe ad four times for a total of 30 seconds on their handset. Joey views the shoe ad as part of playing a skateboarding game, and then goes on to the Financial News Network webpage to receive stock quotes, and receives the same ad campaign from the shoe advertise, which counts as the second viewing of the ad and part of the 30 second duration. Whatever content Joey views, including his uiOne™ Homescreen, Joey sees the shoe ad until the conditions are satisfied.

In FIG. 10, a methodology 940 for interceptor micro-targeting advertisement begins by utilizing a location-informed behavioral profile in order to predict a transaction in block 942, according to one aspect. An advertisement is requested or located in the advertisement cache as an interceptor advertisement opportunity when the predicted transaction is at a competitor business. The advertisement billing rate can be increased, for example, if the advertiser chooses to send advertisements to those going to competitors. Revenue optimizing advertising auctioning can thus increase the priority of such opportunities.

In some aspects, the advertiser chooses to target a specific window of opportunity when the user may be the most susceptible to changing behavior if presented with an advertisement. Thus, in block 946, the location of the mobile subscriber and the time/date are monitored in order to comply with the presentation criteria specified by the advertisement campaign. For example, a user may tend to go to a competitor restaurant for lunch on Fridays at noon. The advertiser may choose to present an advertisement to such users at 11:30 and/or when the user is within three minutes travel based on current average speed to the advertiser's business and/or when the user is within half a mile of the competitor's location. In block 948, a determination is made as to whether the time/proximity conditions have been triggered. If so, the interceptor advertisement is presented in block 950. Although not depicted, the user can interact with the advertisement in a way that could be deemed a success of the advertisement. In the instance of impression advertisement as depicted in block 952, the location of the mobile subscriber is monitored. If a competitor location is entered in block 954, then in block 956, the advertisement is tracked as having failed in this instance. If not a competitor location in block 954, then a determination is made as to whether the interceptor advertiser location has been entered in block 958. If so, then the advertisement can be tracked as having succeeded in block 960. If not the competitor or interceptor location within any reasonable period of time, then the advertisement can be tracked as having had an inconclusive effect in block 962.

In FIG. 11, a methodology 970 for a time couponing on mobile communication devices takes advantage of time tagged conditions (e.g., begin time, target time, and/or end time) associated with advertisements in and advertising repository in block 972, according to one aspect. An advertisement cache in the mobile device is refreshed with timed coupon advertisements in block 974. The advertisement queue is optimized so that timed coupon advertisements are scheduled for presentation within the schedule condition in block 976. Then a determination is made in block 978 that an advertisement is needed for the user interface. If so, then a further determination is made in block 980 to confirm that any begin time condition has been met. If not, the next advertisement in the queue is selected and processing returns to block 980. If the begin time has been met in block 980, then a further determination is made in block 984 as to whether the end time has been exceeded. If so, the advertisement is deleted from the queue in block 986 and the next advertisement in the queue is selected in block 982. If the advertisement end time has not been exceeded in block 984, then the advertisement is displayed on the UI in block 988.

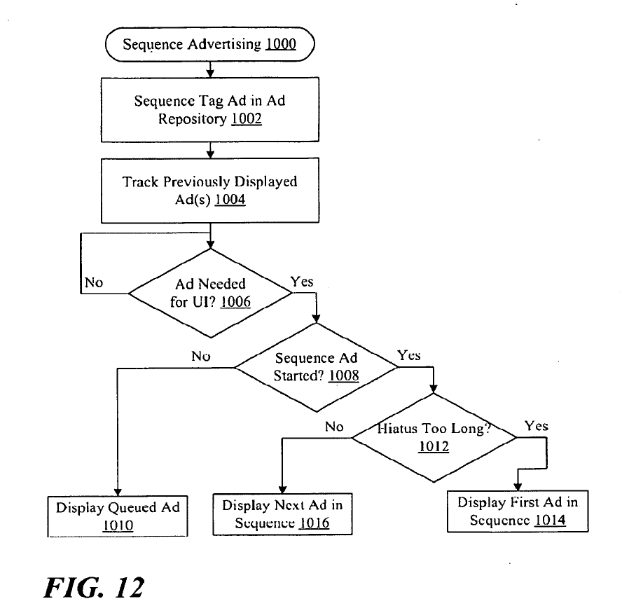

In FIG. 12, a methodology 1000 is depicted for sequence (story) advertising, according to one aspect. In this instance, reach-frequency-time advertising can link a plurality of advertisements that are presented in a sequence in order to tell a story, to parse an otherwise too complicated subject, or other objectives. In block 1002, a sequence tagged advertisement composed of a plurality of depictions is in the ad repository. The UE tracks previously displayed advertisements in block 1004. This tracking may be used to request additional installments in a sequence that has been started or the entire sequence can be cached on the UE if space permits. In block 1006, a determination is made that an ad is needed for the UI. If it is further determined that a sequence ad has not been previously started in block 1008, then a non-sequence ad is displayed, such as by drawing the next queued ad in block 1010. If in block 1008 a sequence has been started, a further determination can be made in block 1012 as to whether a hiatus between installments has been too long. If so, the first ad in the sequence is displayed in block 1014 and if not, then the next ad in the sequence is displayed 1016.

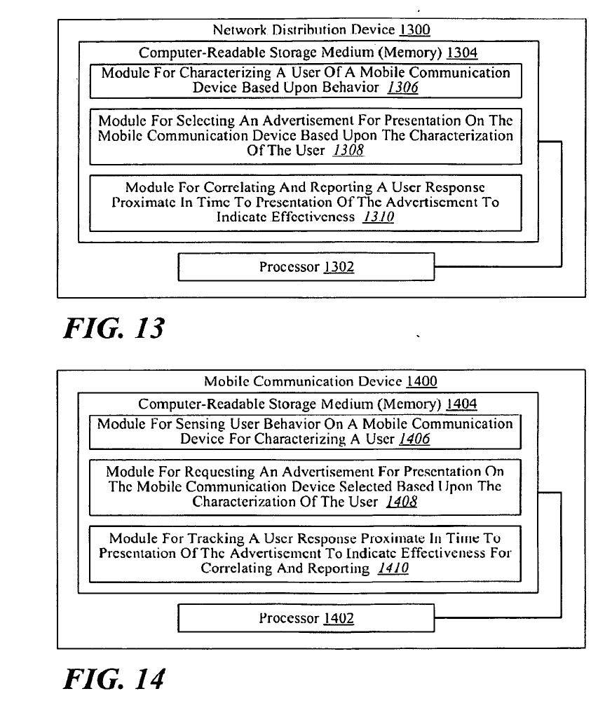

In FIG. 13, an exemplary network distribution device 1300 has at least one processor 1302 for executing modules in computer-readable storage medium (memory) 1304 for distributing advertisement content to a mobile communication device. The network distribution device 1300 can comprise the marketplace platform 106, 302 (FIGS. 1-2) or perform a portion of functions thereof. In the illustrative modules depicted, a first module 1306 provides means for characterizing a user of a mobile communication device based upon behavior. A second module 1308 provides means for selecting an advertisement for presentation on the mobile communication device based upon the characterization of the user. A third module 1310 provides means for correlating and reporting a user response proximate in time to presentation of the advertisement to indicate effectiveness.

In FIG. 14, an exemplary mobile communication device 1400 has at least one processor 1402 for executing modules in a computer-readable storage medium (memory) 1404 for presenting advertisement. In the illustrative modules depicted, a first module 1406 provides means for sensing user behavior on a mobile communication device for characterizing a user. A second module 1408 provides means for requesting an advertisement for presentation on the mobile communication device selected based upon the characterization of the user. A third module 1410 provides means for tracking a user response proximate in time to presentation of the advertisement to indicate effectiveness for correlating and reporting

It should be appreciated with the benefit of the foregoing disclosure that a number of advantages are provided for inventory management. Inventory owners (e.g., content publishers, operators, or original equipment manufacturers (OEMs)) can make inventory available to the Mobile Advertising (Marketplace) Platform through an inventory management system. The advertising inventory can be categorized by site/content type, format, and expected volumes. Objectives and business rules, restrictions, opt-in guidance and target revenue models can be entered. Links and access to their own user profiling and demographic data can be managed for utilization by the Mobile Advertising (Marketplace) Platform. This ad inventory can includes WAP (e.g., on/off portal), applications (e.g., BREW/J2ME), user interface (e.g., uiOne™/mShop™), mobile content (e.g., BGSS/BXSS/BLSS), messaging (e.g., SMS/MMS/IM), video (e.g., VOD/Broadcast/Streaming), audio, and search. Forecasting and yield management by the marketplace platform allow a content publisher to forecast their ad revenue based on historical inventory utilization and content and subscriber target segment. Targeting and personalization is facilitated by grouping content types and inventory against target segments allowing more focused Campaign Management. Example target segments include homemaker, college student, etc. Tracking and optimization by the marketplace platform allow content publishers to track the ad spend on their content so they can optimize their future content and campaigns. For example, a game may have too many ads, thus reducing click through rates. In the latter scenario, the game developer can reduce the number of ads so as to increase the interactivity of the campaign. Business rules and inventory owner objectives are supported by the marketplace platform, allowing inventory owners to enter business rules and guidance on acceptable frequency and nature of advertising, blocked advertisers or categories (e.g., competitors, alcohol, adult content, etc.). Setting overall inventory objectives are contemplated (e.g., maximize revenue across all campaigns, maximize revenue per spot, maximize ads sold by specific advertiser, optimize service/ad mix, etc.). It is further contemplated that final approval on all campaigns can be controlled through the marketplace platform. In one instance, this is provided as a negative check off, not a positive check on. In some implementations, for example, no campaign may run on a partner operator network without explicit operator approval and sign off. Business rules can be input such that inventory owners have the ability to restrict or prioritize certain campaigns, categories, or advertisers to meet a variety of campaign and user experience objectives. They can also manage user experience through limits on frequency and repetition of ads delivered to users. Permissions can provide access control lists to govern who can authorize what type of activities. Prioritization can be facilitated such that advertisers might pay a premium to the service that may not be reflected in the CPM of the Ad. Business contracts that are not quantifiable in the service may cause one ad to be displayed over another higher CPM ad. In addition, an application programming interface (API) allows Content Publishers to interact with the service remotely using an XML interface for sending and receiving data to the system.

It should further be appreciated with the benefit of the foregoing disclosure that a number of advantages are provided for campaign management, such as for an agency or advertiser that is the campaign owner. The Campaign owner books, prices, targets, approve, and deliver specific formatted ads for subscribers through a campaign management interface. They enter campaign objectives, schedule, timing, targeting and budget information.

Campaign management will present views of available inventory and target segments to aid booking and campaign optimization. Campaign Management checks with inventory database to ensure that required inventory exists and is available. Once confirmed by Campaign owner, the campaign can be then sent to the inventory owner for approval. Once approved by the inventory owner, the campaign is posted as live on the system.

It should further be appreciated that with the benefit of the foregoing disclosure that a number of advantages are provided for campaign creation. Examples of functions supported include: (a) Create—The ability to create a new campaign, set name, objectives, etc.; (b) Modify—The ability to modify a campaign already in progress. This allows for course adjustments based on current success metrics; (c) Cancel/Delete—The ability to cancel or delete a campaign that is currently in progress; (d) Ingest—Automated and manual ingestion of creative ad assets. Initially in both a web interface and batch from the Ad Agency. Both business rules and assets can be facilitated through automated or manual input solutions; (e) Transcoding—In some implementations automated transcoding to various formats can be avoided so that the size and quality of the ads are appropriate for different handsets; (f) Forecast—Forecast available inventory can be made for usage through various content channels, subscriber profiles, and market segments. Provide Number of Ad spaces (against content), last month inventory and utilization, this month inventory and utilization; (g) Schedule—Schedule inventory based on time frames, expiration date/time, time of day during period of time; (h) Frequency Control—How many times a subscriber will view an ad in a given time period. Additional measurements are other ads, other content, actions the subscriber performed, and the amount of time a subscriber views the ad; (i) View/Report—Campaign View for Operator, Agency, Content Owner; and (j) API—A content management API can allow advertisers to interact with the service remotely using an XML interface for sending and receiving data to the system.

It should be further appreciated with the benefit of the foregoing disclosure that a number of advantages are provided for pricing options. A common measurement of mobile advertising needs can be created to unify the Ad Platform. For example, Cost Per Thousand (Mille) (CPM) for impression based advertising can be similar to the Internet but for WAP. CPM is a measurement of how many dollars for a thousand impressions. Cost per Click (CPC), Click to Call, Click to WAP, Click to Buy, are other measurable actions. Each time a subscriber actively selects an ad, an action occurs which causes an ad payment. Sometimes these cost per click ads have impression based ad revenue associated with them, but they can also be posted for free. Cost per Acquisition (CPA) tracks actual customer acquisition rather than click through rates. CPA can be difficult to track due to the acquisition tracking mechanisms for verifying a customer was fully acquired and paid. Sponsorship can be based upon sponsoring an ad campaign, site, content, application, or UI based on the same parameters noted earlier. Sponsorship can lock up content for a period of time or for specific target segment and prevents other ads from appearing in that space. Sponsorship deals can be negotiated between the content owner and the advertiser. Paid placement is space purchased without the ability to change out the ad from an ad Platform or Ad Engine (e.g., in a game, application, video, user interface, etc.). Paid placement has a reporting component so the advertiser knows how often their inventory was interacted with, either for branding or activity.

Principles of advertising metrics become extendable to mobile advertising but with additional benefits to behavior profiling and user interaction. Broadcast TV Advertising utilizes target or gross rating points. Target rating points take into consideration reach and frequency. Reach is the Target Market Segment the Advertiser wished to address. Frequency is the number of times a subscriber views the advertisement independent of the ad size (10, 15, or 30 seconds).

It should further be appreciated with the benefit of the foregoing disclosure that a number of advantages are provided related to a subscriber profile generated and maintained by the marketplace platform. Subscriber profile can capture all relevant demographic, behavior, and contextual data of the subscriber to better target the advertising spend. Subscriber profile data can originate from many sources including the subscriber directly (entered), the subscriber passively (tracked), the Operator, or 3rd party databases with verified data elements. In one aspect, subscriber provided data in some instances are not considered verified as consumers rarely accurately portray themselves. In another aspect, operator provided data may not accurately represent the user of the handset and cannot be relied on for advertising accuracy. Behavior data captured at the handset can be considered a true reflection of the behavior state of the subscriber. It should be appreciated that various reliability weighting can be applied to subscriber provider data, operator provided data, and handset detected behavior data in order to account for deemed reliability for characterizing a user.

Demographic Data is discrete verifiable data that provide for age, income, fender, address, telephone number, handset type, operator, birth date, education, marital status, tariff, preferences, etc. Demographic data can have a bulk upload function for taking data from outside databases. Behavior data bears upon values, beliefs, attitudes, lifestyle, and behavior including hobbies, interests, music taste, profession, clubs, associations, memberships, purchase history. Content viewed or downloaded. GPS tracked home, work, play, eat, or shop locations. Responses to previous campaigns, Digital content (e.g., applications, media, and content), physical goods (e.g., Amazon, eBay), services, click-to-xxx purchases, frequency, time on a screen, and value.

In one aspect, contextual data relates to time and location data, including time spent at each location, transition times between these destinations, live/work/play schedule, time of day and location for various activities. Subscriber is a location at a specified time.

It should further be appreciated with the benefit of the foregoing that a number of advantages are provided for segment targeting. Segmented targeting allows the advertiser and ad agency to more accurately access specific content and subscriber profile groups the advertiser wishes to target. Aggregated subscriber profiles allow for segmenting the market into large segments for targeting. Content targeting allows an advertiser to target their ads at a content type based on the content itself (e.g., Madden 2008=target Sports, specifically ESPN ad spend). The advertisers can target content data (e.g., published content groups such as sports, teen, etc., or media type such as WAP, app, message, media (video/audio), UI, etc. They can target demographic data such as age bands, social class bands, gender, region, handset group, operator, etc. The advertisers can target behavior data, such as organizations (e.g., Subscriber Profile: Catholic Church=Religious group: Christian; Marathon Runner=Health Conscious Group; Purchases Pop Music=market other pop music artists; Click-to-Call Subscriber=open to immediate purchase activity and high probability of immediate sale.). They can target contextual, such as content type (e.g., sports, recipes, etc.), location such as traveling (i.e., provide no home advertising), time of day (e.g., night, no coffee or breakfast advertisements).

It should further be appreciated that reporting and analytics are supported by the marketplace platform. Comprehensive reporting solution allows both advertiser and operator to understand the success or failure of their campaign. Analytics can be required to make course adjustments to make the next advertising campaign more successful. Reporting and analytics can include data collection, tracking, and auditing of some or all advertising transactions. Data collection can include accounting for impressions and Click-to-XXX rates supplied by the Ad technology providers through an API to a central reporting server. Data collection can include verification against a trusted auditing and tracking mechanism. The data collection can include auditing to provide an audit trail verifying for the operator that the sales network and the sales delivery are accurately represented. This audit trail can be used to increase quality of service (QOS) over time for ad delivery and tracking. Data collection can support reporting, both real-time or for pre-defined periods. For instance, pre-defined reports can describe ad activity (i.e., how often the ad was viewed in time periods), inventory use (i.e., how much of the inventory was used with what content), geographic (i.e., where the ads were viewed), measurement (i.e., how well is a campaign performing against stated goals), stakeholder (i.e., reports meant for a specific stakeholder in the ecosystem) such as advertiser (e.g., here were the ads used, publisher, subscribers, time, response rate, etc.), content publisher (e.g., campaign reports, subscriber reports, revenue, etc.), operator (e.g., campaign reports, subscriber reports, inventory usage, revenue based on advertiser and content publisher, etc.), and the marketplace platform (e.g., aggregated information by operator, publisher, advertiser including overall revenue earned, etc.). Customized reports can also be supported to allow the user to select variables against available data, including but not limited to: (a) Time—date, day of week, time of day, time range in a day, etc.; and (b) Target segment (e.g., Demographic, Behavior, Contextual, Purchase Behavior ), campaign specific data (e.g.,. on or off deck, unique subscribers, etc.)

It should thus be appreciated with the benefit of the foregoing that the analytics supported herein allow the advertiser and ad agency to make modifications to their advertising strategy to have more successful campaigns that ultimately cost them less money to manage while still raising CPM for those targeted subscribers the advertiser wishes to reach. The analytics engine can become more complex as new personal profile information is allowed and captured in the database. The analytics can evaluate time factors (i.e., Past, Present, Future against various demographic and Behavior data). The analytics can get determine a cause (e.g., what was the cause of the success or failure of the campaign). The analytics can support planning and optimization, such as by simulating results from a campaign based on historical data. Allowances can be made for modifications of a campaign to optimize the campaign. The analytics can support a scheduler to help the media agency determine the best allocation of an ad buy against time of day and day of week information as well as content demographic data. The analytics can support forecasting in order to predict marketing plan results against historical data prior to running the campaign. The analytics can further support performance of the campaign as measured by success criteria established before the campaign began. In addition, new advertising measurement concepts can include impression based advertising and geo-fenced stores tracking arrival of the specific subscriber. The analytics can also support modeling and analysis to identify relationships between different variables and elements of ad campaigns and user profiling. The process of test, validate and optimize can build back into a targeting model facilitating capture of rules and relationships.

It should be appreciated that one or more aspects described herein segregate certain functions for network-level storage and processing and other functions for performance by a mobile communication device. It should be appreciated with the benefit of the present disclosure that applications consistent with aspects can include configurations with more distributed processing to reduce computational overhead at a centralized location and/or reduce communication loads. Alternatively, some limited capability mobile devices can be served with mobile advertising with additional processing centralized.

The various illustrative logics, logical blocks, modules, and circuits described in connection with the versions disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of codes and/or instructions on a machine readable medium and/or computer readable medium, which may be incorporated into a computer program product.

While the foregoing disclosure discusses illustrative aspects and/or implementations, it should be noted that various changes and modifications could be made herein without departing from the scope of the described aspects and/or implementations as defined by the appended claims. Furthermore, although elements of the described aspects and/or implementations may be described or claimed in the singular, the plural is contemplated unless limitation to the singular is explicitly stated. Additionally, all or a portion of any aspect and/or implementation may be utilized with all or a portion of any other aspect and/or implementation, unless stated otherwise.

What is claimed is:

1. A method for distributing advertisement content to a mobile communication device, comprising:
characterizing a user of a mobile communication device based upon behavior;
selecting an advertisement for presentation on the mobile communication device based upon the characterization of the user; and
correlating and reporting a user response proximate in time to presentation of the advertisement to indicate effectiveness.

2. The method of claim 1, wherein characterizing the user further comprises correlating a location of the mobile communication device with a location of a business.

3. The method of claim 1, further comprising:
tagging an advertisement with a condition associated with the presentation of the advertisement required to be completed by the mobile communication device for deeming presentation of the advertisement complete.

4. The method of claim 3, further comprising tagging the advertisement with a time condition of cumulative duration of presentation.

5. The method of claim 4, further comprising:
selecting the advertisement for presentation on the mobile communication device in a first user interface depiction to complete a portion of the time condition; and
subsequently selecting the advertisement for presentation on the mobile communication device in a second user interface depiction to complete a further portion of the time condition.

6. The method of claim 5 wherein the first and second user interface depictions are selected from a group consisting of a browser screen, a wireless device menu screen, or a game console screen.

7. The method of claim 3, further comprising tagging the advertisement with a frequency condition of a minimum count of presentations.

8. The method of claim 7, further comprising tagging the advertisement with a time condition of cumulative duration of presentation, wherein both frequency and time conditions are to be satisfied for deeming presentation of the advertisement complete.

9. The method of claim 3, further comprising tagging the advertisement with a schedule condition constraining a time period for presentation of the advertisement.

10. The method of claim 3, further comprising tagging the advertisement with a location condition constraining presentation of the advertisement to a defined location of the mobile communication device.

11. The method of claim 10, further comprising:
characterizing a behavior of the user to frequent a competitor location; and
tagging the advertisement with a condition selected to precede a forecasted return to the competitor location.

12. The method of claim 11, further comprising tagging the advertisement with a location condition forecasted to precede reaching the competitor location.

13. The method of claim 11, further comprising tagging the advertisement with a time condition forecasted to precede reaching the competitor location based on characterization of the user.

14. The method of claim 3, further comprising tagging the advertisement with a sequence condition constraining presentation of the advertisement within a sequence of a plurality of advertisements.

15. The method of claim 1, further comprising depersonalizing the report of the user response by removing user identification.

16. The method of claim 1, further comprising correlating and reporting the user response by identifying a location of the mobile communication device as corresponding to a business associated with the advertisement.

17. The method of claim 1, further comprising correlating and reporting the user response by determining that the user made a call to a business associated with the advertisement.

18. The method of claim 17, further comprising correlating and reporting the user response by determining that the user activated a link in the advertisement to automatically dial the business associated with the advertisement.

19. The method of claim 1, further comprising correlating and reporting the user response by determining that the user made an input to save the advertisement for further access via the user interface of the mobile communication.

20. The method of claim 1, further comprising correlating and reporting the user response by detecting a demographic input, a behavioral input, and a contextual input associated with the user.

21. At least one processor configured to distribute advertisement content to a mobile communication device, comprising:
a first module for characterizing a user of a mobile communication device based upon behavior;
a second module for selecting an advertisement for presentation on the mobile communication device based upon the characterization of the user; and
a third module for correlating and reporting a user response proximate in time to presentation of the advertisement to indicate effectiveness.

22. A computer program product, comprising:
a computer-readable medium comprising:
at least one instruction for causing a computer to characterize a user of a mobile communication device based upon behavior;
at least one instruction for causing a computer to select an advertisement for presentation on the mobile communication device based upon the characterization of the user; and
at least one instruction for causing a computer to correlate and report a user response proximate in time to presentation of the advertisement to indicate effectiveness.

23. An apparatus for distributing advertisement content to a mobile communication device, comprising:
means for characterizing a user of a mobile communication device based upon behavior;
means for selecting an advertisement for presentation on the mobile communication device based upon the characterization of the user; and
means for correlating and reporting a user response proximate in time to presentation of the advertisement to indicate effectiveness.

24. An apparatus for distributing advertisement content to a mobile communication device, comprising:
a storage device containing data structure of behavior of a user sensed by a mobile communication device;
a marketplace platform for developing a characterization of the user based upon the behavior, and for interfacing with an advertisement platform to select an advertisement for presentation on the mobile communication device based upon the characterization of the user; and
an advertisement tracking component for correlating and reporting a user response proximate in time to presentation of the advertisement to indicate effectiveness.

25. The apparatus of claim 24, further comprising a campaign management interface for inputting a tag on the formatted advertisement, the tag containing a condition associated with the presentation of the advertisement required to be completed by the mobile communication device for deeming presentation of the advertisement complete.

26. The apparatus of claim 25, wherein the campaign management interface inputs a tag condition selected from a group consisting of a time duration, a schedule constraint, sequence, and a frequency count.

27. The apparatus of claim 24, further comprising a location database of business associated with advertisements, the advertisement tracking component correlates a location of the mobile communication device with a business location in the location database.

28. The apparatus of claim 24, further comprising the advertisement tracking component for correlating and reporting the user response by detecting a demographic input, a behavioral input, and a contextual input associated with the user.

29. A method for presenting advertisement content on a mobile communication device, comprising:
sensing user behavior on a mobile communication device for characterizing a user;
requesting an advertisement for presentation on the mobile communication device selected based upon the characterization of the user; and
tracking a user response proximate in time to presentation of the advertisement to indicate effectiveness for correlating and reporting.

30. The method of claim 29, wherein sensing user behavior further comprises sensing a location of the mobile communication device for correlating with a location of a business.

31. The method of claim 29, further comprising presenting an advertisement in accordance with a condition to be completed by the mobile communication device for deeming presentation of the advertisement complete.

32. The method of claim 31, further comprising presenting the advertisement in accordance with a time condition of cumulative duration of presentation.

33. The method of claim 31, further comprising presenting the advertisement in accordance with a frequency condition of a minimum count of presentations.

34. The method of claim 33, further comprising presenting the advertisement in accordance with both a minimum time condition of cumulative duration of presentation and the minimum count.

35. The method of claim 31, further comprising presenting the advertisement in accordance with a schedule condition constraining a time period for presentation of the advertisement.

36. The method of claim 31, further comprising presenting the advertisement in accordance with a location condition constraining presentation of the advertisement to a defined location of the mobile communication device.

37. The method of claim 36, wherein sensing the location of the mobile device has characterized a behavior of the user as frequenting a competitor business, the method further comprising presenting the advertisement in accordance with a condition selected to precede a forecasted return to the competitor location.

38. The method of claim 37, further comprising presenting the advertisement in accordance with a location condition forecasted to precede reaching the competitor location.

39. The method of claim 37, further comprising presenting the advertisement in accordance with a time condition forecasted to precede reaching the competitor location based on characterization of the user.

40. The method of claim 31, further comprising presenting the advertisement in accordance with a sequence condition constraining presentation of the advertisement within a sequence of a plurality of advertisements.

41. The method of claim 29, further comprising securing the report of the user response by removing user identification.

42. The method of claim 29, further comprising sensing the user response by sensing a location of the mobile communication device for correlating and reporting as corresponding to a business associated with the advertisement.

43. The method of claim 29, further comprising:
reporting a configuration of the mobile communication device from a plurality of configurations; and
receiving and presenting the advertisement formatted for presentation capabilities of the configuration of the mobile communication device.

44. The method of claim 29, further comprising sensing the user response by determining that the user made a call to a business associated with the advertisement.

45. The method of claim 44, further comprising sensing the user response by sensing user activating a link in the advertisement and automatically dialing the business associated with the advertisement.

46. The method of claim 29, further comprising sensing the user response by saving the advertisement for further access via the user interface of the mobile communication in response to a user input.

47. The method of claim 29, further comprising tracking the user response proximate in time to presentation of the advertisement to indicate effectiveness by receiving a selected one of a demographic input, a behavioral input, or a contextual input by the user.

48. At least one processor configured to present advertisement content on a mobile communication device, comprising:
a first module for sensing user behavior on a mobile communication device for characterizing a user;
a second module for requesting an advertisement for presentation on the mobile communication device selected based upon the characterization of the user; and
a third module for tracking a user response proximate in time to presentation of the advertisement to indicate effectiveness for correlating and reporting.

49. A computer program product, comprising:
a computer-readable medium comprising:
at least one instruction for causing a computer to sense user behavior on a mobile communication device for characterizing a user;
at least one instruction for causing a computer to request an advertisement for presentation on the mobile communication device selected based upon the characterization of the user; and
at least one instruction for causing a computer to track a user response proximate in time to presentation of the advertisement to indicate effectiveness for correlating and reporting.

50. An apparatus for presenting advertisement content on a mobile communication device, comprising:
means for sensing user behavior on a mobile communication device for characterizing a user;
means for requesting an advertisement for presentation on the mobile communication device selected based upon the characterization of the user; and
means for tracking a user response proximate in time to presentation of the advertisement to indicate effectiveness for correlating and reporting.

51. An apparatus for presenting advertisement content on a mobile communication device, comprising:
a sensor of behavior of a user of a mobile communication device;
a transmitting component for reporting the sensed behavior to a marketplace platform for developing a characterization of the user based upon the behavior;
a receiving component for receiving an advertisement selected by the marketplace platform for presentation on the mobile communication device based upon the characterization of the user; and
an advertisement tracking component for tracking a user response proximate in time to presentation of the advertisement to indicate effectiveness,
wherein the transmitting component reports the tracked user response to the marketplace platform.

52. The apparatus of claim 51, further comprising a user interface response to a user interaction command with the presented advertisement to sense user behavior.

53. The apparatus of claim 51, further comprising an advertisement scheduler for presenting the advertisement subject to a condition associated with the advertisement.

54. The apparatus of claim 53, wherein the advertisement scheduler presents the advertisement subject to a tagged condition selected from a group consisting of a time duration, a schedule constraint, sequence, and a frequency count.

55. The apparatus of claim 51, further comprising a location sensor responsive to a location of the mobile communication device.

56. The apparatus of claim 51, further comprising the advertisement tracking component tracking a selected one of a demographic input, a behavioral input, and a contextual input by the user.
